(19) United States
(12) Patent Application Publication
(10) Pub. No.: US 2024/0399975 A1
(43) Pub. Date: Dec. 5, 2024

(54) DISPLAY DEVICE, AND TRANSPORTATION DEVICE

(71) Applicants: InnoLux Corporation, Miao-Li County (TW); CARUX TECHNOLOGY PTE. LTD., SINGAPORE (SG)

(72) Inventors: Ta-Chin HUANG, Tainan (Tainan Science Park) (TW); Ching-I LO, Tainan (Tainan Science Park) (TW); Hung-Ching LEE, Tainan (Tainan Science Park) (TW); Hsien-Chang CHEN, Tainan (Tainan Science Park) (TW); Sheng-Yu CHIOU, Miao-Li County (TW)

(21) Appl. No.: 18/647,052

(22) Filed: Apr. 26, 2024

(30) Foreign Application Priority Data
Jun. 1, 2023 (CN) 202310641594.3

(51) Int. Cl. B60R 11/02; B60R 11/00

(52) U.S. Cl. CPC B60R 11/0235; B60R 2011/0028; B60R 2011/0085; B60R 2011/0092

(57) ABSTRACT

A display device is provide. The display device is within a transportation device having a first seating area, including a display unit, a mechanical platform, and a mechanical shaft assembly. The mechanical platform is configured to correspond to the first seating area. The mechanical shaft assembly is disposed on the mechanical platform and including a first shaft portion, a second shaft portion, and a third shaft portion. The first shaft portion is connected to the display unit and driving the display unit to move along a horizontal direction. The second shaft portion is connected to an upper end of the display unit and driving the display unit to rotate around a second axis. The third shaft portion is connected to the second shaft portion and driving the display unit to rotate around a third axis.

### CROSS REFERENCE TO RELATED APPLICATIONS

This application claims priority of China Patent Application No. 202310641594.3, filed on Jun. 1, 2023, the entirety of which is incorporated by reference herein.

### BACKGROUND OF THE INVENTION

### Field of the Invention

The present disclosure relates to a display device and a transportation device, and particularly to a display device within a transportation device having a first seating area.

### Description of the Related Art

Due to limited screen accommodation space, the back seat screens of existing transportation devices usually have a smaller size, making it less comfortable for back seat passengers to view the screen images.

Therefore, there is a need for a display device design that may improve the comfort of passengers viewing screen images.

### BRIEF SUMMARY OF THE INVENTION

An embodiment of the present invention provides a display device within a transportation device having a first seating area, including a display unit, a mechanical platform, and a mechanical shaft assembly. The mechanical platform is configured to correspond to the first seating area. The mechanical shaft assembly is disposed on the mechanical platform and including a first shaft portion, a second shaft portion, and a third shaft portion. The first shaft portion is connected to the display unit and driving the display unit to move along a horizontal direction. The second shaft portion is connected to an upper end of the display unit and driving the display unit to rotate around a second axis. The third shaft portion is connected to the second shaft portion and driving the display unit to rotate around a third axis.

An embodiment of the present invention provides a transportation device, including a first seating area, a display unit, a top, an accommodation space, and a control interface. The top is corresponding to the first seating area. The accommodation space is configured to accommodate the display unit and located adjacent to the top. The control interface is electrically connected to the display unit. When the control interface provides an expanding signal to the display unit, the display unit moves away from an accommodation position in the accommodation space.

### BRIEF DESCRIPTION OF THE DRAWINGS

The present invention may be more fully understood by reading the subsequent detailed description and examples with references made to the accompanying drawings, wherein:

FIG. 1 is a schematic view of a transportation device according to some embodiments of the present disclosure.

FIG. 2 is a schematic view of the display unit, the mechanical platform, and the mechanical shaft assembly according to some embodiments of the present disclosure.

FIG. 3A is a schematic view of the mechanical shaft assembly driving the display unit to move relative to the mechanical platform according to some embodiments of the present disclosure.

FIG. 3B is a schematic view of the mechanical shaft assembly driving the display unit to move relative to the mechanical platform according to some embodiments of the present disclosure.

FIG. 3C is a schematic view of the mechanical shaft assembly driving the display unit to move relative to the mechanical platform according to some embodiments of the present disclosure.

FIG. 4 is a schematic view of a transportation device according to some embodiments of the present disclosure.

FIG. 5 is a schematic view of the display unit located at different positions.

FIG. 6A is a schematic view of a transportation device according to some embodiments of the present disclosure.

FIG. 6B is a schematic view of a transportation device according to some embodiments of the present disclosure.

FIG. 7A is a schematic view of a display unit according to some embodiments of the present disclosure.

FIG. 7B is a schematic view of the display unit according to some embodiments of the present disclosure.

FIG. 7C is a schematic view of a display unit according to some embodiments of the present disclosure.

FIG. 7D is a schematic view of a display unit according to some embodiments of the present disclosure.

FIG. 8 is a schematic view of a display unit control process and a display unit control process according to some embodiments of the present disclosure.

### DETAILED DESCRIPTION OF THE INVENTION

The present disclosure may be more clearly understood by referring to the following description and the appended drawings. It should be noted that, for the sake of the simplicity of the drawings and comprehensibility for readers, only a portion of the light-emitting unit is illustrated in multiple figures in the present disclosure, and the specific components in the figures are not drawn to scale. In addition, the number and size of each component in the drawings merely serve as an example, and are not intended to limit the scope of the present disclosure. Furthermore, similar and/or corresponding numerals may be used in different embodiments for describing some embodiments simply and clearly, but they do not represent any relationship between different embodiments and/or structures discussed below.

Certain terms may be used throughout the present disclosure and the appended claims to refer to particular elements. Those skilled in the art will understand that electronic device manufacturers may refer to the same components by different names. The present specification is not intended to distinguish between components that have the same function but different names. In the following specification and claims, the words “including”, “comprising”, “having” and the like are open-ended words, so they should be interpreted as meaning “including but not limited to . . . ” Therefore, when the terms “including”, “comprising”, and/or “having” are used in the description of the disclosure, the presence of corresponding features, regions, steps, operations and/or components is specified without excluding the presence of one or more other features, regions, steps, operations and/or components.

In addition, in this specification, relative expressions may be used. For example, “lower”, “bottom”, “higher” or “top” are used to describe the position of one element relative to another. It should be noted that if a device is flipped upside down, an element that is “lower” will become an element that is “higher”.

When a corresponding component (i.e. a film layer or region) is referred to as “on another component”, it may be directly on another component, or there may be other components in between. On the other hand, when a component is referred “directly on another component”, there is no component between the former two. In addition, when a component is referred “on another component”, the two components have an up-down relationship in the top view, and this component can be above or below the other component, and this up-down relationship depends on the orientation of the device.

The terms “about,”, “essentially,” or “substantially” are generally interpreted as within 20% of a given value or range, or as interpreted as within 10%, 5%, 3%, 2%, 1%, or 0.5% of a given value or range.

In the present application, when mentioning that the A element overlaps the B element, it means to include at least partial overlap.

It should be understood that, although the terms “first”, “second” etc. may be used herein to describe various elements, layers and/or portions, and these elements, layers, and/or portions should not be limited by these terms. These terms are only used to distinguish one element, layer, or portion. Thus, a first element, layer or portion discussed below could be termed a second element, layer or portion without departing from the teachings of some embodiments of the present disclosure. In addition, for the sake of brevity, terms such as “first” and “second” may not be used in the description to distinguish different elements. As long as it does not depart from the scope defined by the appended claims, the first element and/or the second element described in the appended claims can be interpreted as any element that meets the description in the specification.

In the present disclosure, the thickness, length, and width can be measured by using an optical microscope, and the thickness can be measured by the cross-sectional image in the electron microscope, but it is not limited thereto. In addition, a certain error may be present in a comparison with any two values or directions. If the first direction is perpendicular to the second direction, the angle between the first direction and the second direction may be between 80 degrees (≥80 degrees) and 100 degrees (≤100 degrees). If the first direction is parallel to the second direction, the angle between the first direction and the second direction may be between 0 degree (≥0 degree) and 10 degrees (≤10 degrees).

It should be noted that the technical solutions provided by different embodiments below may be interchangeable, combined or mixed to form another embodiment without departing from the spirit of the present disclosure.

Unless defined otherwise, all terms (including technical and scientific terms) used herein have the same meaning as commonly understood by one having ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined in the present disclosure.

The electronic device may include a display device, a backlight device, an antenna device, a sensing device or a splicing device, but it is not limited thereto. The electronic device may be a bendable or flexible electronic device. The display device may be a non-self-luminous display device or a self-luminous display device. The antenna device may be a liquid crystal type antenna device or a non-liquid crystal type antenna device, and the sensing device may be a sensing device for sensing capacitance, light, thermal energy or ultrasonic waves, but it is not limited thereto. The electronic devices may include passive devices and active devices, such as capacitors, resistors, inductors, diodes, transistors, and the like. The diodes may include light emitting diodes or photodiodes. The light emitting diode may include, for example, an organic light emitting diode (OLED), a mini LED, a micro LED or a quantum dot LED, but it is not limited thereto. The splicing device may be, for example, a display splicing device or an antenna splicing device, but it is not limited thereto. It should be noted that, the electronic device may be any combination mentioned above, but it is not limited thereto. In the following, a display device is used as an electronic device or a splicing device to illustrate the content of the present application, but the present application is not limited thereto.

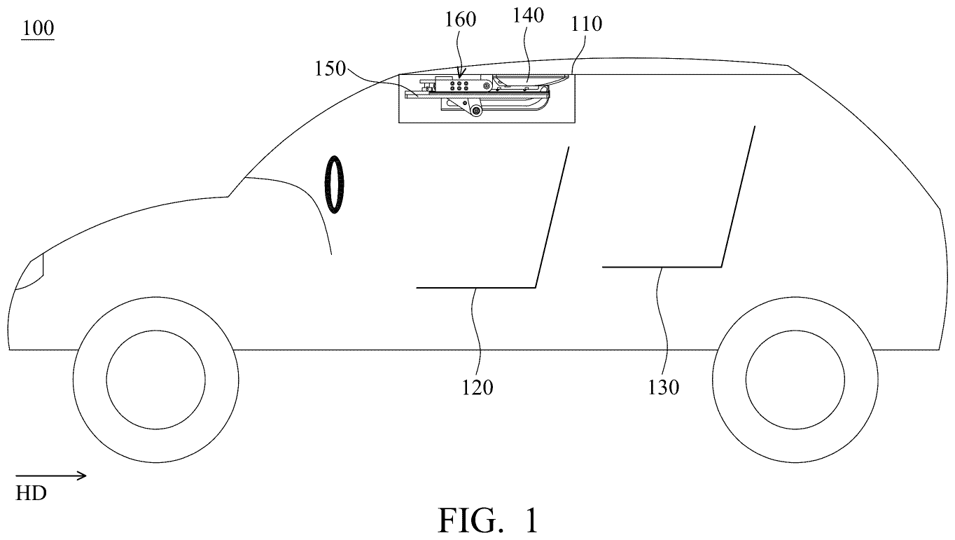

Please refer to FIG. 1, FIG. 1 is a schematic view of a transportation device 100 according to some embodiments of the present disclosure. It should be noted that although FIG. 1 shows the transportation device 100 as a car, the present disclosure is not limited thereto.

According to some embodiments of the present disclosure, the transportation device 100 may be other vehicles, aircraft, ships, etc., but the present disclosure is not limited thereto. For example, the transportation device 100 may be a passenger car, a train, a high-speed train, a passenger ship, a submarine, a passenger plane, a helicopter, etc., but the present disclosure is not limited thereto.

As shown in FIG. 1, the transportation device 100 may include a top 110, a first seating area 120, a second seating area 130, and a display device 140. Wherein, the display device (not shown) includes a display unit 140, a mechanical platform 150, and a mechanical shaft assembly 160.

The first seating area 120 may be located in front of the second seating area 130, and the first seating area 120 and the second seating area 130 may be arranged along a horizontal direction HD.

According to some embodiments of the present disclosure, the horizontal direction HD may be a direction extending from the front to the rear of the transportation device 100; therefore, the first seating area 120 may be called a front seat, and the second seating area 130 may be called a back seat.

Please continue to refer to FIG. 1, the mechanical platform 150 may correspond to the first seating area 120. For example, the mechanical platform 150 may be disposed on the top 110, and the mechanical platform 150 may be disposed above the first seating area 120. The top 110 may be the ceiling of the interior of transportation device 100. According to some embodiments of the present disclosure, the mechanical platform 150 may also be connected to the outer shell (e.g., vehicle shell) of the transportation device 100.

The display unit 140 may be connected to mechanical platform 150 via mechanical shaft assembly 160. That is, the display unit 140 is also accommodated on the top 110, and the display unit 140 is accommodated above the first seating area 120. In some embodiments, the display unit 140 is located in an accommodation position 253 between the mechanical platform 150 and a first top 110, but the present disclosure is not limited thereto.

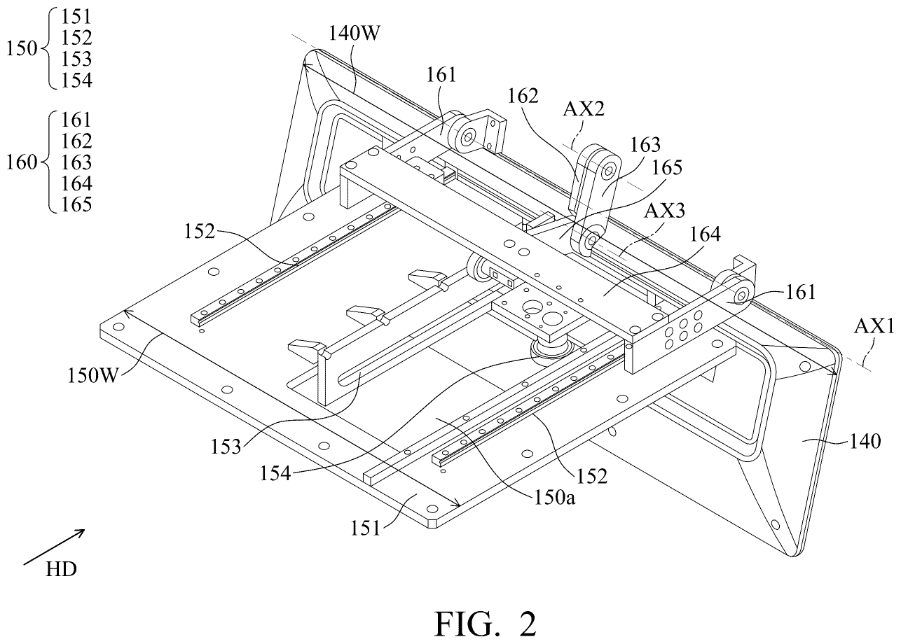

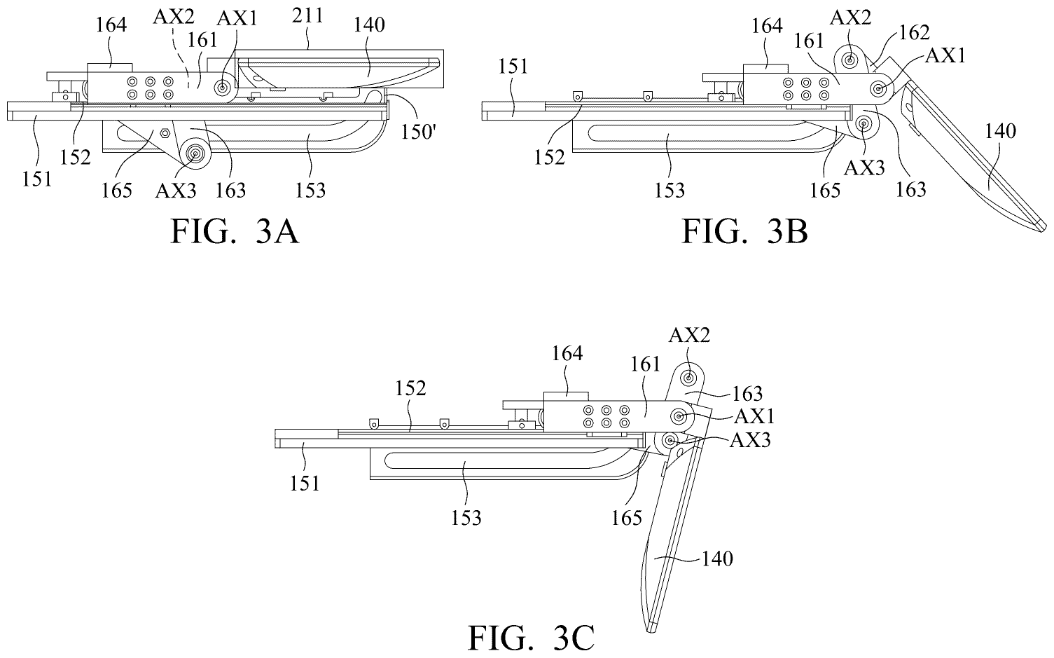

Please refer to FIG. 2, FIG. 3A, FIG. 3B and FIG. 3C. FIG. 2 is a schematic view of the display unit 140, the mechanical platform 150, and the mechanical shaft assembly 160 according to some embodiments of the present disclosure. FIG. 3A is a schematic view of the mechanical shaft assembly 160 driving the display unit 140 to move relative to the mechanical platform 150 according to some embodiments of the present disclosure. FIG. 3B is a schematic view of the mechanical shaft assembly 160 driving the display unit 140 to move relative to the mechanical platform 150 according to some embodiments of the present disclosure. FIG. 3C is a schematic view of the mechanical shaft assembly 160 driving the display unit 140 to move relative to the mechanical platform 150 according to some embodiments of the present disclosure.

As shown in FIG. 2, FIG. 3A, FIG. 3B and FIG. 3C, the mechanical shaft assembly 160 may be disposed on the mechanical platform 150, and the mechanical shaft assembly 160 may connect the display unit 140 to the mechanical platform 150.

The mechanical platform 150 may include a body 151, guide rails 152, a sliding rail 153, and a motor 154. The mechanical shaft assembly 160 may include a first shaft portion 161, a second shaft portion 162, a third shaft portion 163, a transverse shaft 164, and a fourth shaft portion 164.

The first shaft portion 161 may be connected to the upper end of the display unit 140, and the other end of the first shaft portion 161 may be connected to the transverse shaft 164.

The motor 154 of the mechanical platform 150 may drive the transverse shaft 164 to move, so that the first shaft portion 161 may move along the guide rails 152 provided on the body 151 of the mechanical platform 150.

The guide rail 152 may extend along the horizontal direction HD, so that the first shaft portion 161 may drive the display unit 140 to move along the horizontal direction HD. According to some embodiments of the present disclosure, the mechanical shaft assembly 160 may have two first shaft portions 161, so as to be more firmly connected to the display unit 140. In some embodiments, the display unit 140 moves a distance along the guide rails 152 from the accommodation space 211 (or the accommodation position 253) to the folded position (not labeled) through the first shaft portion 161, but the present disclosure is not limited thereto.

The second shaft portion 162 may be disposed between the two first shaft portions 161. One end of the second shaft portion 162 may be connected to the upper end of the display unit 140, and the other end of the second shaft portion 162 may be connected to the third shaft portion 163. Moreover, the second shaft portion 162 may drive the display unit 140 to rotate around a second axis AX2.

The third shaft portion 163 may be disposed between the two first shaft portions 161. One end of the third shaft portion 163 may be connected to the second shaft portion 162, and the other end of the third shaft portion 163 may be connected to the fourth shaft portion 165.

The fourth shaft portion 165 may be disposed between the third shaft portion 163 and the body 151 of the mechanical platform 150. One end of the fourth shaft portion 165 may be connected to the third shaft portion 163, and the other end of the fourth shaft portion 165 may be connected to the transverse shaft 164. Accordingly, the fourth shaft portion 165 may be indirectly connected to the first shaft portion 161.

When the motor 154 of the mechanical platform 150 drives the horizontal axis 164 to move, the fourth shaft portion 165 may move along the sliding rail 153 of the mechanical platform 150. The sliding rail 153 is connected to the body 151 of the mechanical platform 150.

Moreover, the sliding rail 153 extends along the horizontal direction HD below the body 151 of the mechanical platform 150, and in a cross-sectional direction, the sliding track of the sliding rail 153 passes upward through the body 151 of the mechanical platform 150 at the end 150′ of the mechanical platform 150 (FIG. 3A).

When the fourth shaft portion 165 moves along the sliding rail 153 of the mechanical platform 150, the third shaft portion 163 will also move with the fourth shaft portion 165, thereby driving the display unit 140 to move.

According to some embodiments of the present disclosure, the third axis portion 163 may drive the display unit 140 to rotate around a third axis AX3.

A width 150W of the mechanical platform 150 may be smaller than a width 140W of the display unit 140, and the mechanical platform 150 may have a hole 150a. In this way, the size and weight of the mechanical platform 150 may be reduced, thereby reducing the cost or reducing the power consumption (fuel consumption) of the transportation device when traveling.

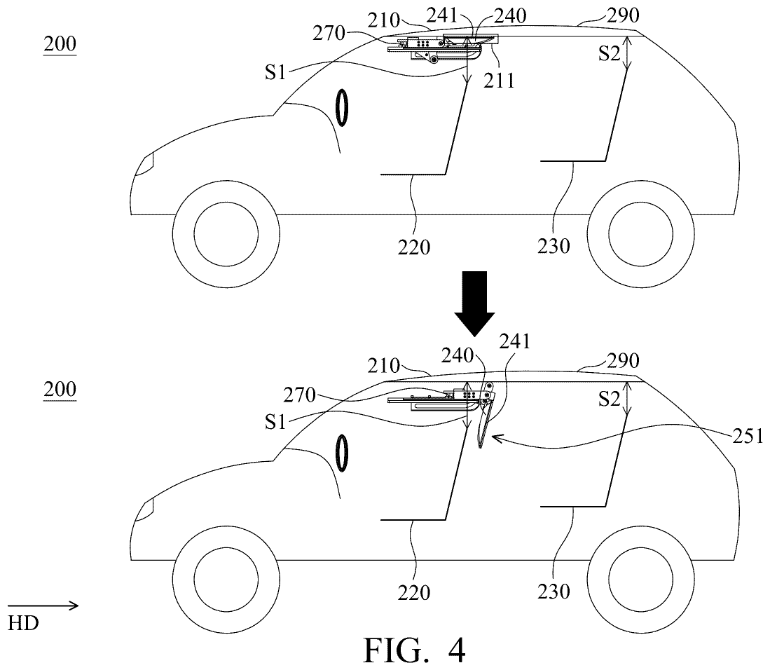

Please refer to FIG. 4, FIG. 4 is a schematic view of a transportation device 200 according to some embodiments of the present disclosure. It should be noted that although FIG. 4 shows the transportation device 200 as a car, the present disclosure is not limited thereto. The transportation device 200 may be similar to the transportation device 100 and will not be repeated here.

The transportation device 200 may include a first top 210, a first seating area 220, a second seating area 230, a display unit 240, a driving source 270, and a second top 290.

The first top 210, the first seating area 220 and the second seating area 230 may be similar to the top 110, the first seating area 120 and the second seating area 130 and will not be repeated here.

The transportation device may further include an accommodation space 211 that is corresponding to the first top 210, and the accommodation space 211 may accommodate the display unit 240. In this embodiment, the accommodation space 211 may be located above the first seating area 220, and in the normal direction of the transportation device 200, the projection of the accommodation space 211 overlaps the first top 210. In other words, the display unit 240 may be accommodated above the first seating area 220. Similarly, the second top 290 may correspond to the second seating area 230; in other words, the second top 290 may be located above the second seating area 230, and the second top 290 may be the ceiling inside the transportation device 200. In some embodiments, the accommodation space may be a space between seats (for example, a driver's seat and a passenger's seat) and the top of the transportation device. The accommodation space may also be an enclosed space enclosed by a shell (not shown) or a semi-open space to accommodate the display unit 240, but it is not limited thereto.

According to some embodiments of the present disclosure, the transportation device 200 is typically designed such that the distance S1 between the first seating area 220 and the first top 210 above the first seating area 220 may be greater than the distance S2 between the second seating area 230 and the second top 210 above the second seating area 230.

Therefore, accommodating the display unit 240 on the first top 210 above the first seating area 220 may effectively utilize the space between the user and the first top 210 above the first seating area 220, and may reduce the oppression of the user sitting in the second seating area 230.

Moreover, since the first top 210 above the first seating area 220 may accommodate a larger-sized display unit 240, the user may have a better viewing experience.

The driving source 270 may drive the display unit 240. According to some embodiments of the present disclosure, the driving source 270 may drive the display unit 240 to move from the accommodation position 253 (which may be located in the accommodation space 211) to an expansion position 251, or the driving source 270 may drive the display unit 240 to move from the expansion position 251 to the accommodation position 253.

When the display unit 240 is not in use, the display unit 240 may be located in the accommodation position 253, so as to prevent the display unit 240 from being damaged, and also prevent the user from hitting the display unit 240 and being injured. For example, when the transportation device 200 is parked, when the display unit 240 is not used, or when no one is seated in the second seating area 230, the display unit 240 may be accommodated in the accommodation position 253.

According to some embodiments of the present disclosure, when the display unit 240 is located in the accommodation position 253, a display panel 241 of the display unit 240 may face the first top 210 of the transportation device 200. However, according to some other embodiments of the present disclosure, when the display unit 240 is located in the accommodation position 253, a display panel 241 of the display unit 240 may face away from the first top 210 of the transportation device 200.

When the display unit 240 is to be used, the display unit 240 may be located in the expansion position 251 so that the user may view the content displayed by the display unit 240.

According to some embodiments of the present disclosure, the expansion position 251 may be between the first seating area 220 and the second seating area 230. According to some embodiments of the present disclosure, when the display unit 240 is located at the expansion position 251, the display panel 241 of the display unit 240 may face the second seating area 230, so that the user seated in the second seating area 230 may view the content displayed by the display unit 240.

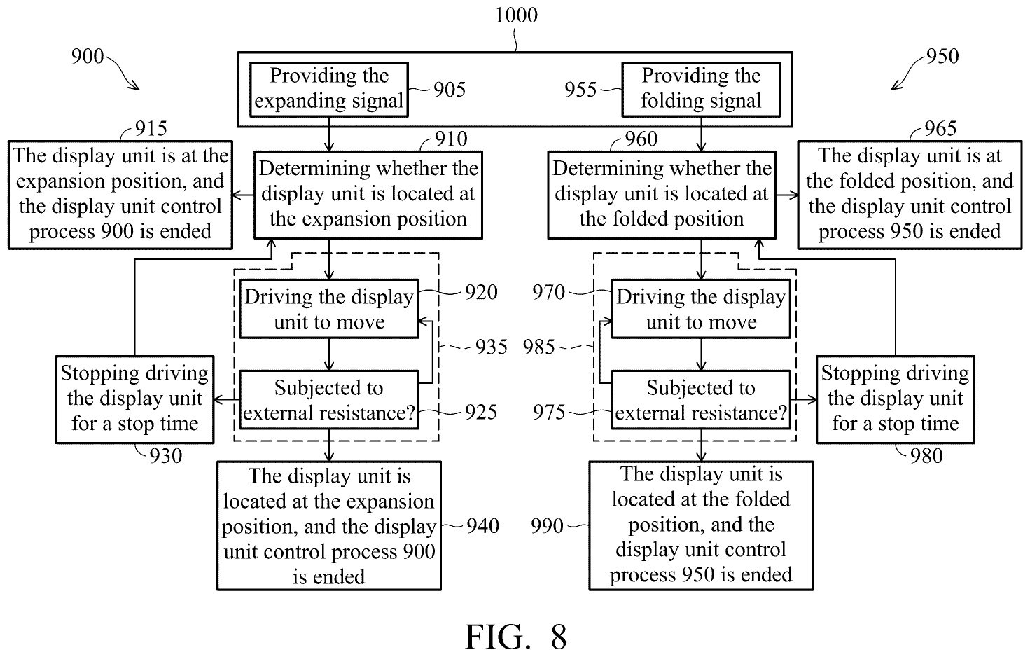

The transportation device 200 may further include a control interface (may refer to FIG. 8). The control interface include, but is not limited to, circuit boards, controllers, transceivers, or other suitable control elements. The control interface may be electrically connected to the display unit 240 to provide different signals to the display unit 240. When the control interface provides an expanding signal to the display unit 240, the display unit 240 may move away from the accommodation position 253, and the display unit 240 may move toward the expansion position 251.

When the control interface provides an accommodating signal to the display unit 240, the display unit 240 may move toward the accommodating position 253, and the display unit 240 may move away from the expansion position 251.

The transportation device 200 may include a sensor (not shown). According to some embodiments of the present disclosure, the sensor may be a position sensor or a force sensor, but the present disclosure is not limited thereto.

According to some embodiments of the present disclosure, the position sensor or force sensor may be disposed on the display unit 240 or the mechanical platform that supports the display unit 240 (similar to the mechanical platform 150).

According to some embodiments of the present disclosure, the position sensor may sense the position of the display unit 240. For example, the position sensor may sense whether the display unit 240 is located at the accommodation position 253 or the expansion position 251.

According to some embodiments of the present disclosure, when the control interface provides an expanding signal to the display unit 240 and when the position sensor senses that the display unit 240 is not in the expansion position 251, the driving source 270 drives the display unit 240 to move toward the expansion position 251 until The position sensor senses that the display unit 240 is at the expansion position 251.

According to some embodiments of the present disclosure, when the control interface provides an accommodating signal to the display unit 240 and when the position sensor senses that the display unit 240 is not in the accommodation position 253, the driving source 270 drives the display unit 240 to move toward the accommodation position 253 until the position sensor detects that the display unit 240 is at the accommodation position 253.

According to some embodiments of the present disclosure, the force sensor may sense whether the display unit 240 is subjected to an external force. For example, the force sensor may sense whether the display unit 240 is in contact with or hits other objects during movement, such as a user or other elements of the transportation device 200.

According to some embodiments of the present disclosure, when the driving source 270 drives the display unit 240 to move toward the expansion position 251, and when the display unit 240 touches or hits a user or other elements of the transportation device 200, the force sensor may provide a signal to the driving source 270 to drive the display unit 240 to stop moving or move toward the accommodation position 253.

According to some embodiments of the present disclosure, when the driving source 270 drives the display unit 240 to move toward the accommodation position 253, and when the display unit 240 touches or hits a user or other elements of the transportation device 200, the force sensor may provide a signal to the driving source 270 to drive the display unit 240 to stop moving or move toward the expansion position 251.

According to some other embodiments of the present disclosure, when the control interface provides an expansion signal to the display unit 240, the driving source 270 drives the display unit 240 to move toward the expansion position 251 for an expansion time, so that the display unit 240 is located in the expansion position 251.

According to some other embodiments of the present disclosure, when the control interface provides an accommodation signal to the display unit 240, the driving source 270 drives the display unit 240 to move toward the accommodation position 253 for an accommodation time, so that the display unit 240 is located at the accommodation position 253.

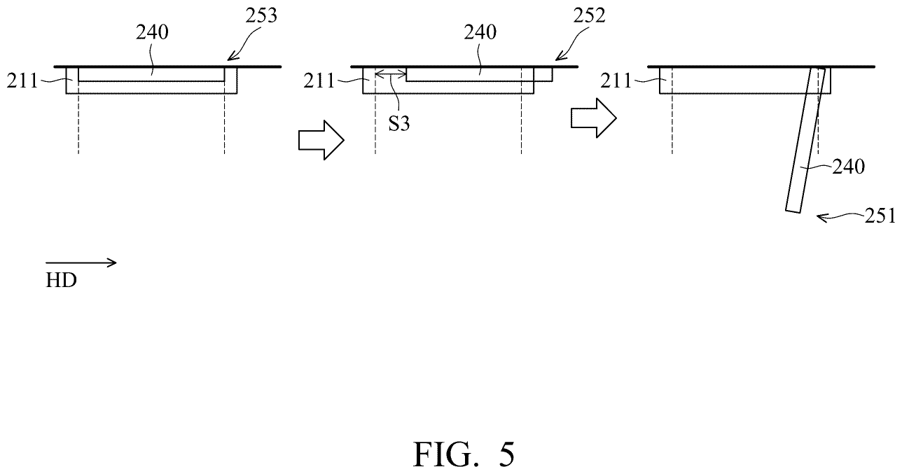

Please refer to FIG. 5, FIG. 5 is a schematic view of the display unit 240 located at different positions.

In the embodiment of FIG. 5, the folded position 252 may be between the accommodation position 253 and the expansion position. The folded position 252 and the accommodation position 253 may be separated by a distance S3. According to some embodiments of the present disclosure, the distance S3 may be parallel to the horizontal direction HD.

When the display unit 240 is in the folded position 252, the display unit 240 may quickly move to the accommodation position 253 or the expansion position 251.

For example, when the user does not use the display unit 240 temporarily, the display unit 240 may be folded in the folded position 252, so that when the user wants to use the display unit 240, the display unit 240 may be quickly moved to the expansion position 251.

For example, when encountering an emergency situation (e.g., emergency braking, collision, etc.), the display unit 240 may quickly move from the expansion position 251 to the folded position 252 to reduce the possibility of the user hitting the display unit 240.

According to some embodiments of the present disclosure, the display unit 240 may move along the horizontal direction HD between the accommodation position 253 and the retracting position 252. According to some embodiments of the present disclosure, when the display unit 240 moves between the accommodation position 253 and the folded position 252 along the horizontal direction HD, the display unit 240 may not rotate.

For example, if the display panel 241 of the display unit 240 faces the first top 210 of the transportation device 200 when the display unit 240 is located in the accommodation position 253, then the display panel 241 of the display unit 240 faces the first top 210 of the transportation device 200 when the display unit 240 is located in the folded position 252,

In the embodiment shown in FIG. 5, the control interface (may refer to FIG. 8) may provide a folding signal to the display unit 240. Moreover, when the control interface provides a folding signal to the display unit 240, the display unit 240 may move toward the folded position 252.

According to some embodiments of the present disclosure, the display unit 240 may move from the accommodation position 253 to the folded position 252. According to some embodiments of the present disclosure, the display unit 240 may move from the expansion position 251 to the folded position 252.

According to some embodiments of the present disclosure, the sensors of the transportation device 200 may also be optical sensors, ultrasonic sensors, etc., but the present disclosure is not limited thereto.

The sensor may detect the position of the user, and then adjust the distance from the accommodation position 253 to the folded position 252. For example, the sensor may sense the position of the second seating area 230, the body shape of the user, whether there is a child seat, or whether there are other shields, etc., so as to determine the distance from the accommodation position 253 to the folded position 252.

In this way, it is possible to prevent the display unit 240 from contacting or hitting the user or other elements of the transportation device 200 when the display unit 240 is moving.

According to some embodiments of the present disclosure, the sensor may be correspondingly arranged in the middle of the first seating area 220. For example, when the first seating area 220 is the area from the driver's seat to the passenger's seat, the sensor may be arranged in the central control area (between the driver's seat and the passenger's seat).

According to some embodiments of the present disclosure, the sensor may be arranged at the corner of the top of the transportation device 200. For example, the sensor may be disposed at a corner of the second top 290 above the second seating area 230, so as to sense the position of the second seating area 230, the user's size, whether there is a child seat, or whether there is a child seat, or whether there are other shields, etc.

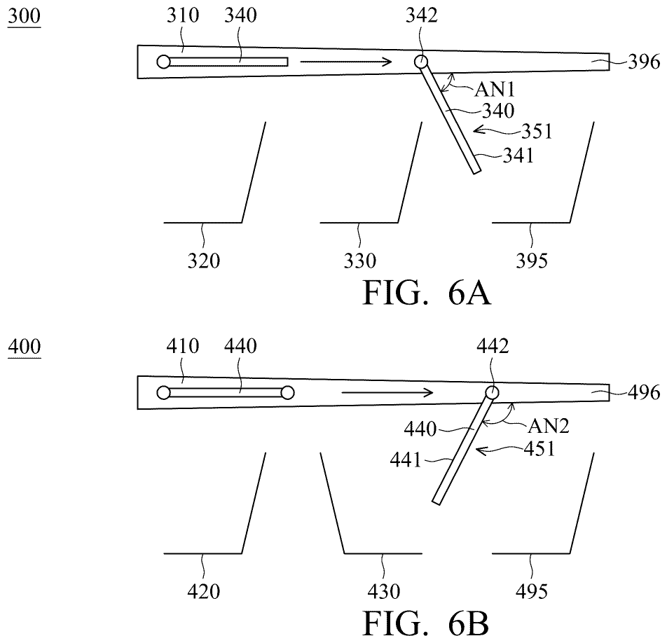

Please refer to FIG. 6A, FIG. 6A is a schematic view of a transportation device 300 according to some embodiments of the present disclosure.

Most of the elements and configurations of the transportation device 300 are similar to those of the transportation device 200, and the similarities will not be repeated here.

In the embodiment of FIG. 6A, the transportation device 300 may further include a third seating area 395. The third seating area 395 may be closer to the rear of the transportation device 300 than the second seating area 330. In other words, the second seating area 330 may be located between the first seating area 320 and the third seating area 395.

As shown in FIG. 6A, the display unit 340 may be move from the first top 310 to the expansion position 351 between the second seating area 330 and the third seating area 395. That is, the expansion position 351 may be closer to the rear of the transportation device 300 than the second seating area 330.

Furthermore, the display panel 341 of the display unit 340 may face the third seating area 395 so that the user sitting in the third seating area 395 may view the content displayed on the display unit 340.

In the embodiment of FIG. 6A, the display unit 340 may be rotated by a first rotation shaft, and there may be an included angle AN1 between the display unit 340 and a third top 396 above the third seating area 395. Different angles AN1 may be selected so that the user sitting in the third seating area 395 may comfortably view the content displayed on the display unit 340.

Please refer to FIG. 6B, FIG. 6B is a schematic view of a transportation device 400 according to some embodiments of the present disclosure.

Most of the elements and configurations of the transportation device 400 are similar to those of the transportation device 300, and the similarities will not be repeated here.

As shown in FIG. 6B, the second seating area 430 may optionally face the rear of the transportation device 400 (that is, facing away from the first seating area 420 or facing the third seating area 495). The display unit 440 may move from the first top 410 above the first seating area 420 to an expansion position 451 between the second seating area 430 and the third seating area 495. That is, the expansion position 451 may be closer to the rear of the transportation device 400 than the second seating area 430.

Furthermore, the display panel 441 of the display unit 440 may face the second seating area 430 so that users sitting in the second seating area 430 may view the content displayed on the display unit 440.

In the embodiment of FIG. 6B, the display unit 440 may be rotated by a second rotating shaft 442, and there may be an included angle AN2 between the display unit 440 and the third top 496 above the third seating area 495.

According to some embodiments of the present disclosure, the included angle AN1 may be the same as the included angle AN2. According to some embodiments of the present disclosure, the included angle AN1 may be different from the included angle AN2. Different included angles AN2 may be selected so that the user sitting in the second seating area 430 may comfortably view the content displayed on the display unit 440.

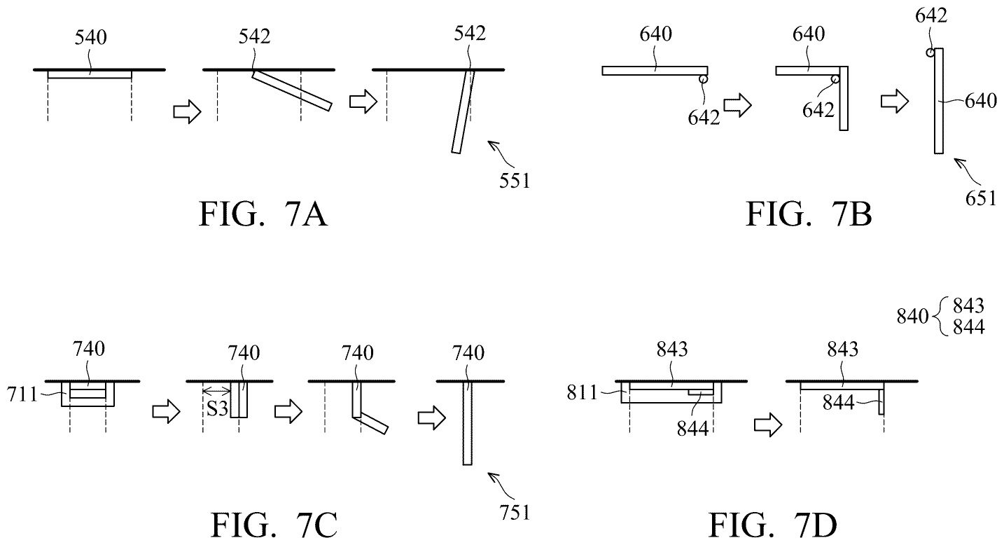

Please refer to FIG. 7A, FIG. 7A is a schematic view of a display unit 540 according to some embodiments of the present disclosure. The display unit 540 may be similar to the display unit 240, and the similarity will not be repeated here.

In the embodiment of FIG. 7A, the display unit 540 includes a flat display unit or a curved display unit, but it is not limited thereto. The display unit 540 may be rotated to the expansion position 551 by a rotating shaft 542, and the folded position (not labeled) may be in the accommodation space (not labeled).

Please refer to FIG. 7B, FIG. 7B is a schematic view of the display unit 640 according to some embodiments of the present disclosure. The display unit 640 may be similar to the display unit 240, and the similarities will not be repeated here.

In the embodiment of FIG. 7B, the display unit 640 includes a flexible display unit (for example: a rollable display unit). The display unit 640 may be bent to the expansion position 651 by rotating a rotating shaft 642. In addition, in this embodiment, the folded position (not labeled) may be in the accommodation space (not labeled).

In this way, the space required for the display unit 640 to move to the expansion position 651 is reduced, which may prevent the user from touching the display unit 640, thereby prevent the display unit 640 from being damaged or prevent the user from being injured.

Please refer to FIG. 7C, FIG. 7C is a schematic view of a display unit 740 according to some embodiments of the present disclosure. The display unit 740 may be similar to the display unit 240, and the similarities will not be repeated here.

In the embodiment of FIG. 7C, the display unit 740 includes a flexible display unit (e.g., a foldable display unit), so that the display unit 740 may be folded in half in the accommodation space 711. Moreover, after the display unit 740 is moved and rotated to the folded position, the folded panel is expanded to the expansion position 751 for viewing by the user. In addition, in some embodiments, the display unit 740 may move a distance S3 from the accommodation space (not labeled), then the display unit 740 rotates to the folded position (not labeled), and then the display unit 740 is expanded to the expansion position 751. In other embodiments, the display unit 740 may be rotated to a folded position (not labeled), the accommodation space is separated from the folded position by a distance S3, and the display unit 740 is expanded to the expansion position 751.

In this way, the space of the accommodation space 711 may be saved, and the accommodation space 711 may accommodate a display unit 740 with a larger size. Moreover, the space required for the movement and rotation of the display unit 740 is reduced, which may reduce the chance of the user touching the display unit 740, thereby preventing the display unit 740 from being damaged or preventing the user from being injured.

Please refer to FIG. 7D, FIG. 7D is a schematic view of a display unit 840 according to some embodiments of the present disclosure. The display unit 840 may be similar to the display unit 240, and the similarity will not be repeated here.

In the embodiment of FIG. 7D, the display unit 840 may include a main display unit 843 and an auxiliary display unit 844. When the main display unit 843 and the auxiliary display unit 844 are accommodated in the accommodation space 811, the auxiliary display unit 844 may overlap the main display unit 843 so that the main display unit 843 is between the auxiliary display unit 844 and the first top 810. In this way, the space of the accommodation space 811 may be saved, and the accommodation space 811 may accommodate the main display unit 843 and the secondary display unit 844 with larger sizes.

Moreover, when the user only needs to view text or small images, the main display unit may not be expanded, and the auxiliary display unit 844 may be expanded separately so that the user may easily operate the auxiliary display unit 844. Furthermore, when the user needs to view a larger image, the main display unit 843 may be expanded (not shown) so that the user may view the main display unit 843 comfortably. In this way, the main display unit 843 or the auxiliary display unit 844 may be expanded according to needs, so as to increase operational flexibility.

Please refer to FIG. 8, FIG. 8 is a schematic view of a display unit control process 900 and a display unit control process 950 according to some embodiments of the present disclosure.

The display unit control process 900 may include a plurality of operations and loops. For example, the display unit control process 900 may include operation 905, operation 910, operation 915, operation 920, operation 925, operation 930, loop 935, and operation 940.

In operation 905, a control interface 1000 may provide an expanding signal. According to some embodiments of the present disclosure, in operation 905, the control interface 1000 may provide an expanding signal to the display unit or the driving source.

In operation 910, determining whether the display unit is located at a specific location. According to some embodiments of the present disclosure, in operation 910, determining whether the display unit is located at the expansion position through the position sensor.

If the display unit is in the specific position (e.g., the expansion position), then proceed to operation 915. If the display unit is not located in the specific position (e.g., the expansion position), then proceed to operation 920.

In operation 915, the driving source may not drive the display unit, and the display unit may stay in the expansion position. After operation 915, the display unit is in the expansion position, and the display unit control process 900 may be ended.

In operation 920, the driving source may drive the display unit. For example, in operation 920, the driving source may drive the display unit to move toward the expansion position.

In operation 925, determining whether the display unit is subjected to external resistance. According to some embodiments of the present disclosure, determining whether the display unit is subjected to external resistance through the force sensor. For example, in operation 925, the force sensor may determine whether the display unit is in contact with or hits the user or other elements of the transportation device.

If the sensor (force sensor) determines that the display unit is subjected to an external resistance, it may proceed to operation 930. If the sensor (force sensor) determines that the display unit is not subjected to an external resistance, the resistance is less than the detection threshold, or the resistance disappears, it may proceed to operation 940.

In operation 930, the driving source may stop driving the display unit for a stop time, and the display unit may stay and not move. After operation 930, may return to operation 910.

In FIG. 8, the loop 935 is represented by a dashed box. The loop 935 may include operation 920 and operation 925. The loop 935 may be repeated a plurality of times until the display unit is in the expansion position (operation 940).

In operation 940, the display unit is located in the expansion position, and the display unit control process 900 may be ended.

Through the display unit control process 900, the display unit may be safely and efficiently moved to the expansion position for the user to operate or view the display unit.

Please continue to refer to FIG. 8. The display unit control process 950 may include a plurality of operations and loop. For example, the display unit control process 950 may include operation 955, operation 960, operation 965, operation 970, operation 975, operation 980, loop 985, and operation 990.

In operation 955, the control interface 1000 may provide a folding signal. According to some embodiments of the present disclosure, in operation 955, the control interface 1000 may provide a folding signal to the display unit or the driving source.

In operation 960, determining whether the display unit is located at a specific position. According to some embodiments of the present disclosure, in operation 960, determining whether the display unit is in the folded position through a position sensor.

If the display unit is in a specific position (e.g., a folded position), then proceed to operation 965. If the display unit is not in a specific position (e.g., a folded position), then proceed to operation 970.

In operation 965, the driving source may not drive the display unit, and the display unit may stop in the folded position. After operation 965, the display unit is in the folded position, and the display unit control process 950 may be ended.

In operation 970, the driving source may drive the display unit. For example, in operation 970, the driving source may drive the display unit to move toward the folded position.

In operation 975, determining whether the display unit is subjected to external resistance. According to some embodiments of the present disclosure, determining whether the display unit is subject to external resistance through a force sensor. For example, in operation 975, the force sensor may determine whether the display unit is in contact with or hits the user or other elements of the transportation device.

If the sensor (force sensor) determines that the display unit is subject to external resistance, it may proceed to operation 980. If the sensor (force sensor) determines that the display unit is not subjected to external resistance, the resistance is less than the threshold, or the resistance disappears, then it may proceed to operation 990.

In operation 980, the driving source may stop driving the display unit for a stop time, and the display unit may stay and not move. After operation 980, may return to operation 960.

In FIG. 8, the loop 985 is represented by a dashed box. The loop 985 may include operation 970 and operation 975. The loop 985 may be repeated a plurality of times until the display unit is in the folded position (operation 990).

In operation 990, the display unit is in the folded position, and the display unit control process 950 may be ended.

Through the display unit control process 950, the display unit may be safely and efficiently moved to the folded position, so as to facilitate the user to operate or accommodate the display unit.

Therefore, through the control interface 1000 shown in FIG. 8, the display unit may be optionally moved to different positions safely and efficiently. For example, the display unit may be selected to be safely and efficiently moved to the expansion position via the display unit control process 900; or, the display unit may be selected to be safely and efficiently moved to the collapsed position via the display unit control process 950.

In this embodiment, the folded position and the accommodation position are different positions, and they are separated by a distance S3. In addition, the safety in use of the display device or/and the transportation device may be increased by adjusting the distance S3. In other embodiments, the accommodation position is the folded position. In other words, the distance between the accommodation position and the folded position is 0. Under the premise of this embodiment, the accommodation signal may be a folding signal, but the present application is not limited thereto.

In general, the transportation device of the embodiment of the present disclosure may provide a larger size display unit and may save space of the transportation device. Furthermore, the transportation device provided by the embodiment of the present disclosure will not cause users sitting in the second seating area to feel oppressed. In addition, the transportation device of the embodiment of the present disclosure may provide a safe and miniaturized mechanical platform to well support the display unit. The display unit control process of the embodiment of the present disclosure may also move the display unit to a desired position safely and efficiently.

Although the embodiments and the advantages of the present disclosure have been described above, it should be understood that those skilled in the art may make various changes, substitutions, and alterations to the present disclosure without departing from the spirit and scope of the present disclosure. It should be noted that different embodiments may be arbitrarily combined as other embodiments as long as the combination conforms to the spirit of the present disclosure. In addition, the scope of the present disclosure is not limited to the processes, machines, manufacture, composition, devices, methods and steps in the specific embodiments described in the specification. Those skilled in the art may understand existing or developing processes, machines, manufacture, compositions, devices, methods and steps from some embodiments of the present disclosure. Therefore, the scope of the present disclosure includes the aforementioned processes, machines, manufacture, composition, devices, methods, and steps. Furthermore, each of the appended claims constructs an individual embodiment, and the scope of the present disclosure also includes every combination of the appended claims and embodiments.

What is claimed is:

1. A display device within a transportation device having a first seating area, comprising:
a display unit;
a mechanical platform, configured to correspond to the first seating area; and
a mechanical shaft assembly, disposed on the mechanical platform and comprising:
a first shaft portion, connected to the display unit and driving the display unit to move along a horizontal direction;
a second shaft portion, connected to an upper end of the display unit and driving the display unit to rotate around a second axis; and
a third shaft portion, connected to the second shaft portion and driving the display unit to rotate around a third axis.

2. The display device as claim in claim 1, wherein the mechanical platform comprises:
a body; and
a sliding rail, connected to the body,
a fourth shaft portion, connected to the sliding rail,
characterized in that,
wherein the sliding rail extends along the horizontal direction below the body, and the sliding rail passes upward through the body at one end of the body,
wherein the fourth shaft portion slides in the sliding rail and is connected to the third shaft portion.

3. The display device as claim in claim 1,
characterized in that, a width of the mechanical platform is smaller than a width of the display unit.

4. A transportation device, comprising:
a first seating area;
a display unit;
a top, corresponding to the first seating area;
an accommodation space, configured to accommodate the display unit and located adjacent to the top; and
a control interface, electrically connected to the display unit,
characterized in that,
wherein when the control interface provides an expanding signal to the display unit, the display unit moves away from an accommodation position in the accommodation space.

5. The transportation device as claim in claim 4, characterized in that,
wherein when the control interface provides an accommodating signal to the display unit, the display unit moves towards the accommodation position.

6. The transportation device as claim in claim 4, characterized in that,
wherein when the control interface provides a folding signal to the display unit, the display unit moves towards a folded position.

7. The transportation device as claim in claim 6, characterized in that,
wherein a display panel of the display unit in the folded position faces the top of the transportation device.

8. The transportation device as claim in claim 6, characterized in that,
wherein the folded position is separated from the accommodation position by a distance.

9. The transportation device as claim in claim 6, characterized in that,
wherein the display unit moves along a horizontal direction between the accommodation position and the folded position.

10. The transportation device as claim in claim 4, further comprising:
a second seating area, located behind the first seating area,
characterized in that,
wherein when the control interface provides an expanding signal to the display unit, the display unit moves toward an expansion position,

11. The transportation device as claim in claim 10, characterized in that,
wherein the expansion position is between the first seating area and the second seating area.

12. The transportation device as claim in claim 4, further comprising:
a second seating area, located behind the first seating area,
characterized in that,
wherein when the control interface provides an expanding signal to the display unit, the display unit moves toward an expansion position,
wherein the expansion position is closer to a rear of the transportation devices than the second seating area,

13. The transportation device as claim in claim 12, characterized in that,
wherein when the display unit is in the expansion position, a display panel of the display unit faces toward or faces away from the second seating area.

14. The transportation device as claim in claim 4, further comprising:
a driving source, configured to drive the display device; and
a position sensor, configured to sense the position of the display unit,

15. The transportation device as claim in claim 14, characterized in that,
wherein when the control interface provides the expanding signal to the display unit, and when the position sensor senses that the display unit is not in the expansion position, the driving source drives the display unit to move toward the expansion position,

16. The transportation device as claim in claim 14, characterized in that,
wherein when the control interface provides the folding signal to the display unit and when the position sensor senses that the display unit is not in the folded position, the driving source drives the display unit to move toward the folded position.

17. The transportation device as claim in claim 4, further comprising:
a driving source, configured to drive the display unit,
characterized in that,
wherein when the control interface provides the expanding signal to the display unit, the driving source drives the display unit to move toward the expansion position for an expansion time,

18. The transportation device as claim in claim 17, characterized in that,
wherein after the driving source drives the display unit to move toward the expansion position for the expansion time, the display unit is located at the expansion position,

19. The transportation device as claim in claim 5, further comprising:
a driving source, configured to drive the display unit,
wherein when the control interface provides the accommodation signal to the display unit, the driving source drives the display unit to move toward the accommodation position for an accommodation time,

20. The transportation device as claim in claim 19, characterized in that,
wherein after the driving source drives the display unit to move toward the accommodation position for the accommodation time, the display unit is located at the accommodation position.
